(19) United States
(12) Patent Application Publication
(10) Pub. No.: US 2022/0237715 A1
(43) Pub. Date: Jul. 28, 2022

(54) METHODS, SYSTEMS, APPARATUSES, AND DEVICES FOR FACILITATING DYNAMIC SUSTAINABILITY MAPPING OF REAL ESTATE

(71) Applicant: Liam John Murray, Manly (AU)

(72) Inventor: Liam John Murray, Manly (AU)

(21) Appl. No.: 17/576,770

(22) Filed: Jan. 14, 2022

Related U.S. Application Data
(60) Provisional application No. 63/141,080, filed on Jan. 25, 2021.

(51) Int. Cl. G06Q 50/16; G06Q 50/26

(52) U.S. Cl. CPC G06Q 50/16; G06Q 50/26

(57) ABSTRACT

The present document provides a method for facilitating dynamic sustainability mapping of real estate. Further, the method may include receiving one or more real estate data, analyzing the one or more real estate data using one or more machine learning models, generating one or more processed real estate data for the one or more real estate based on the analyzing, retrieving one or more real estate rating data, analyzing the one or more processed real estate data and the one or more real estate rating data, generating one or more Environmental, Social, and Corporate Governance (ESG) credits for the one or more real estate, transmitting the one or more ESG credits to the one or more user devices, and storing one or more of the one or more real estate data, the one or more processed real estate data, and the one or more ESG credits.

The current application claims a priority to the U.S. provisional patent application Ser. No. 63/141,080 filed on Jan. 25, 2021.

### FIELD OF THE INVENTION

Generally, the present disclosure relates to the field of data processing. More specifically, the present disclosure relates to methods, systems, apparatuses, and devices for facilitating dynamic sustainability mapping of real estate.

### BACKGROUND OF THE INVENTION

The field of data processing is technologically important to several industries, business organizations, and/or individuals. In particular, the use of data processing is prevalent for facilitating dynamic sustainability mapping of real estate.

Nowadays, building and maintaining a real estate portfolio may be a challenging task. Further, real estate assets should comply with international sustainability standards.

Existing techniques for facilitating dynamic sustainability mapping of real estate are deficient with regard to several aspects. For instance, current technologies do not allow a client to analyze data associated with the real estate asset to gather holistic asset-centric and rating-specific insight based on the data. Moreover, current technologies do not facilitate providing ownership of the data to the client, therefore, creating a privacy risk. Further, current technologies do not facilitate the complex data aggregation of the data from other sources (or devices).

Therefore, there is a need for methods, systems, apparatuses, and devices for facilitating dynamic sustainability mapping of real estate that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating dynamic sustainability mapping of real estate, in accordance with some embodiments. The method may include a step of receiving, using a communication device, one or more real estate data associated with one or more real estate from one or more user devices. Further, the method may include a step of analyzing, using a processing device, the one or more real estate data using one or more machine learning models. Further, the one or more machine learning models may be configured for one or more of an image recognition and a data extraction. Further, the method may include a step of generating, using the processing device, one or more processed real estate data for the one or more real estate based on the analyzing. Further, the method may include a step of retrieving, using a storage device, one or more real estate rating data. Further, the one or more real estate rating data may include one or more world green building ratings. Further, the method may include a step of analyzing, using the processing device, the one or more processed real estate data and the one or more real estate rating data. Further, the method may include a step of generating, using the processing device, one or more Environmental, Social, and Corporate Governance (ESG) credits for the one or more real estate based on the analyzing of the one or more processed real estate data and the real estate rating data. Further, the method may include a step of transmitting, using the communication device, the one or more ESG credits to the one or more user devices. Further, the method may include a step of storing, using the storage device, one or more of the one or more real estate data, the one or more processed real estate data, and the one or more ESG credits.

Further disclosed herein is a system for facilitating dynamic sustainability mapping of real estate, in accordance with some embodiments. The system may include a communication device, a processing device, and a storage device. Further, the communication device may be configured for performing a step of receiving one or more real estate data associated with one or more real estate from one or more user devices. Further, the communication device may be configured for performing a step of transmitting one or more ESG credits to the one or more user devices. The processing device may be communicatively coupled with the communication device. Further, the processing device may be configured for performing a step of analyzing the one or more real estate data using one or more machine learning models. Further, the one or more machine learning models may be configured for one or more of an image recognition and a data extraction. Further, the processing device may be configured for performing a step of generating one or more processed real estate data for the one or more real estate based on the analyzing. Further, the processing device may be configured for performing a step of analyzing the one or more processed real estate data and one or more real estate rating data. Further, the processing device may be configured for performing a step of generating the one or more Environmental, Social, and Corporate Governance (ESG) credits for the one or more real estate based on the analyzing of the one or more processed real estate data and the real estate rating data. The storage device may be communicatively coupled with the processing device. Further, the storage device may be configured for performing a step of retrieving the one or more real estate rating data. Further, the one or more real estate rating data may include one or more world green building ratings. Further, the storage device may be configured for performing a step of storing one or more of the one or more real estate data, the one or more processed real estate data, and the one or more ESG credits.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flowchart of a method for facilitating dynamic sustainability mapping of real estate, in accordance with some embodiments.

FIG. 4 is a continuation flowchart of FIG. 3.

FIG. 5 is a flowchart of a method for facilitating dynamic sustainability mapping of real estate in which the method further may include provisioning one or more server resources for the storing one or more of the one or more real estate data, the one or more processed real estate data, and the one or more ESG credits based on the one or more storage requests, in accordance with some embodiments.

FIG. 6 is a flowchart of a method for facilitating dynamic sustainability mapping of real estate in which the method further may include storing the ownership of one or more of the one or more real estate data, the one or more processed real estate data, and the one or more ESG credits, in accordance with some embodiments.

FIG. 7 is a flowchart of a method for facilitating dynamic sustainability mapping of real estate in which the method further may include transmitting one or more of the real estate data, the processed real estate data, and the ESG credit of the real estate to the user device, in accordance with some embodiments.

FIG. 8 is a flowchart of a method for facilitating dynamic sustainability mapping of real estate in which the method further may include provisioning one or more server resources for the processing of the one or more real estate data based on the one or more processing requests, in accordance with some embodiments.

FIG. 9 is a flowchart of a method for facilitating dynamic sustainability mapping of real estate in which the method further may include transmitting the relational performance to the one or more user devices, in accordance with some embodiments.

FIG. 10 is a flowchart of a method for facilitating dynamic sustainability mapping of real estate in which the method further may include analyzing the one or more environmental sensor data using the one or more machine learning models, in accordance with some embodiments.

FIG. 11 is a flowchart of a method for facilitating dynamic sustainability mapping of real estate in which the method further may include transmitting the one or more responses to the one or more user devices, in accordance with some embodiments.

FIG. 12 is a flowchart of a method for facilitating dynamic sustainability mapping of real estate in which the method further may include transmitting the rating of each real estate of the one or more real estate to the one or more user devices, in accordance with some embodiments.

FIG. 13 is a block diagram of a system for facilitating dynamic sustainability mapping of real estate, in accordance with some embodiments.

FIG. 14 is a flowchart of a method for facilitating dynamic sustainability mapping of a building, in accordance with some embodiments.

FIG. 15 is a flowchart of a method for determining relational performance for facilitating the dynamic sustainability mapping of the building, in accordance with some embodiments.

FIG. 16 illustrates a platform as a service associated with the disclosed system for facilitating dynamic sustainability mapping of real estate, in accordance with some embodiments.

FIG. 17 illustrates services associated with the Microsoft™ Power platform, in accordance with some embodiments.

FIG. 18 is a screenshot of a user interface of a software application associated with the disclosed system, in accordance with some embodiments.

FIG. 19 is a screenshot of a user interface of the software application associated with the disclosed system, in accordance with some embodiments.

FIG. 20 is a screenshot of a “BI dashboard” user interface of the software application associated with the disclosed system, in accordance with some embodiments.

FIG. 21 is a screenshot of a “Energy comments” user interface of the software application associated with the disclosed system, in accordance with some embodiments.

FIG. 22 is a screenshot of a “water comments” user interface of the software application associated with the disclosed system, in accordance with some embodiments.

FIG. 23 is a screenshot of a “refrigerant assets” user interface of the software application associated with the disclosed system, in accordance with some embodiments.

FIG. 24 is a screenshot of a “electricity metering” user interface of the software application associated with the disclosed system, in accordance with some embodiments.

FIG. 25 is a screenshot of a “water metering” user interface of the software application associated with the disclosed system, in accordance with some embodiments.

FIG. 26 is a screenshot of a “gas metering” user interface of the software application associated with the disclosed system, in accordance with some embodiments.

FIG. 27 is a screenshot of a “app source” user interface of the Microsoft™ AppSource, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating dynamic sustainability mapping of real estate, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device etc.) corresponding to the performance of the one or more steps, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for facilitating dynamic sustainability mapping of real estate. Further, Build-Apps (an exemplary embodiment of the disclosed system herein) may be associated with a dynamic mapping sustainability process (or process) of using asset-centric computer-aided facilities management (CAFM) technology which directly relates to Environmental, Social and Corporate Governance (ESG) credit levels in commercial real estate according to World Green Building ratings. This process relates such scoring and credits to specific commercial real estate assets and facilitates the rating and audit process. Additionally, the process includes relational performance to the United Nations Sustainable Development Goals (UNSDGs).

Further, the technology associated with the disclosed system uses the Microsoft™ Office 365 architecture and may be a preconfigured Common Data Model (CDM) optimized for owners of large property portfolios. Further, a software application associated with the disclosed system may be configured within a client's Office 365 and the underlying data may be stored, backed up, and owned by the client. This solves the issue of data ownership during the process, moving away from a SaaS (Software as a Service) model to a PaaS (Platform as a Service) collaboration hierarchy.

Further, some conventional systems may prohibit interoperability. Further, some conventional systems may include an influx of Prop Tech without the ability to share data without intervention. Further, some conventional SaaS may give the vendor the responsibility for managing sensitive data. Further, SaaS providers have ownership of the data that creates risk. Further, without structured data, analytics may not be possible and answers may be hard to find. Further, future-proofing and innovation of the existing systems become difficult without Artificial Intelligence (AI) and Machine learning (ML).

Further, the disclosed system may include connectors that allow secure and control integration from other sources. Further, the disclosed system may provide a secure 2-way API connection. Further, the Office365 single sign-on AAD integration allows security to be controlled by the enterprise, not external parties. Further, the layer of apps within the client's Office 365 and underlying data is stored, back up, and owned by the enterprise, not a 3^{rd} party (or the external parties). Further, preconfigured Build-apps Power BI dashboards may give ultimate flexibility for analytics while connected to multiple sources. Further, AI and ML associated with the disclosed system may facilitate picture recognition and document data extraction.

Further, using Microsoft™ Power Platform PaaS (Platform as a Solution) and the software application (such as the Build-Apps), the clients have truly independent and customizable market-leading IWMS (Integrated Workplace Management System).

Further, SERGII associated with the disclosed system has been created as a Microsoft 365 App and may be accessed securely allowing review and edit function on any device with an internet connection. Further, SERGII may be a place to maintain up-to-date data on how your business is tracking in terms of sustainability. Further, the SERGII takes care of your business data relating to the social, environmental, resilience, and governance.

More and more REITs and asset owners may be required to report to investors on the ESG performance of their portfolios. SERGII may consolidate responses to ESG tools such as GRESB, DJSII, WGBC, CDP (BREEAM, LEED, Green Star, etc.). Effectively SERGII may streamline all ESG processes. Further, the disclosed system may be configured for creating a strategically aligned schema that references the UN SDGs.

By aligning ADAMM's data with SERGII's inputs uncovers unparalleled insights to enable ESG improvement across the entire portfolio with clear alignment to the asset management strategy.

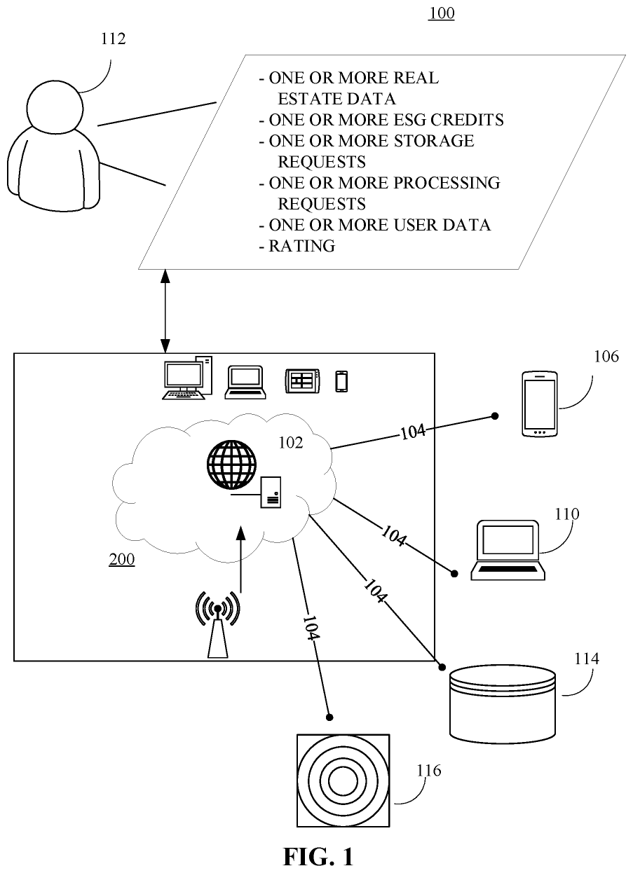

FIG. 1 is an illustration of an online platform 100 consistent with various embodiments of the present disclosure. By way of non-limiting example, the online platform 100 to enable facilitating dynamic sustainability mapping of real estate may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

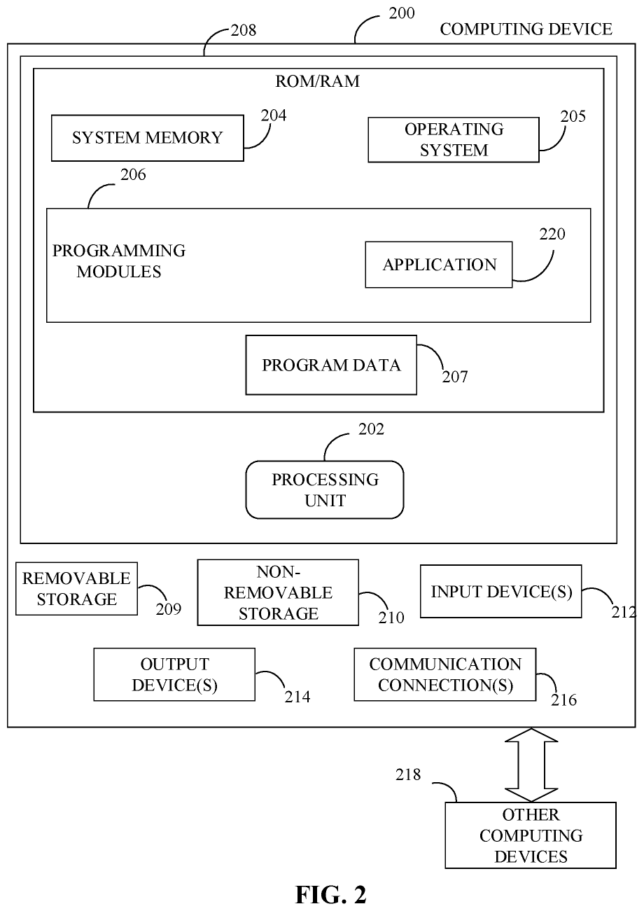

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200′s operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

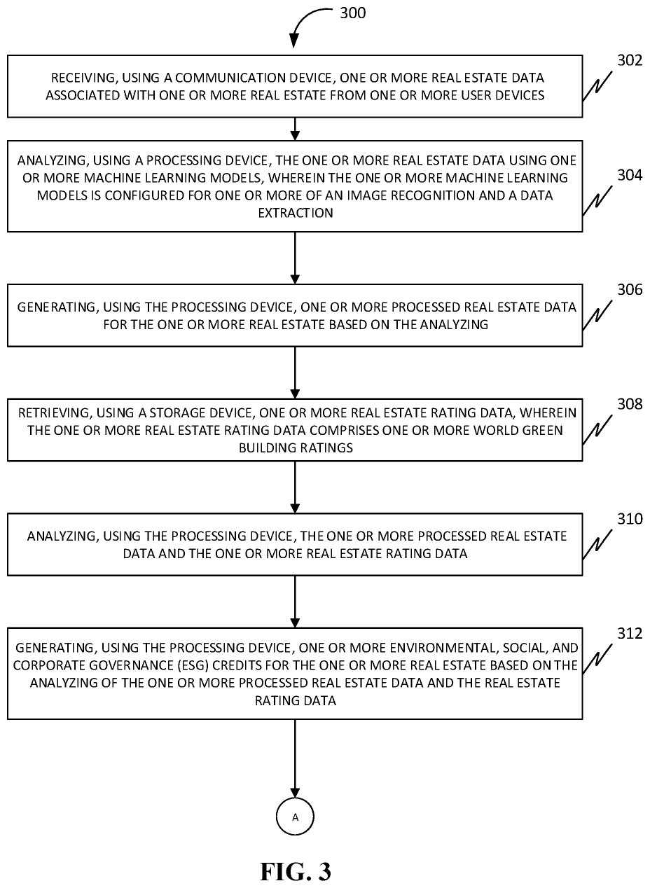

FIG. 3 is a flowchart of a method 300 for facilitating dynamic sustainability mapping of real estate, in accordance with some embodiments.

Further, the method 300 may include a step 302 of receiving, using a communication device (such as a communication device 1302), one or more real estate data associated with one or more real estate from one or more user devices.

Further, the method 300 may include a step 304 of analyzing, using a processing device (such as a processing device 1304), the one or more real estate data using one or more machine learning models. Further, the one or more machine learning models may be configured for one or more of an image recognition and a data extraction.

Further, the method 300 may include a step 306 of generating, using the processing device, one or more processed real estate data for the one or more real estate based on the analyzing. Further, the one or more processed real estate data may include structured data of the one or more real estate. Further, the one or more processed real estate data may include one or more formatted real estate data.

Further, the method 300 may include a step 308 of retrieving, using a storage device (such as a storage device 1306), one or more real estate rating data. Further, the one or more real estate rating data may include one or more world green building ratings.

Further, the method 300 may include a step 310 of analyzing, using the processing device, the one or more processed real estate data and the one or more real estate rating data.

Further, the method 300 may include a step 312 of generating, using the processing device, one or more Environmental, Social, and Corporate Governance (ESG) credits for the one or more real estate based on the analyzing of the one or more processed real estate data and the real estate rating data.

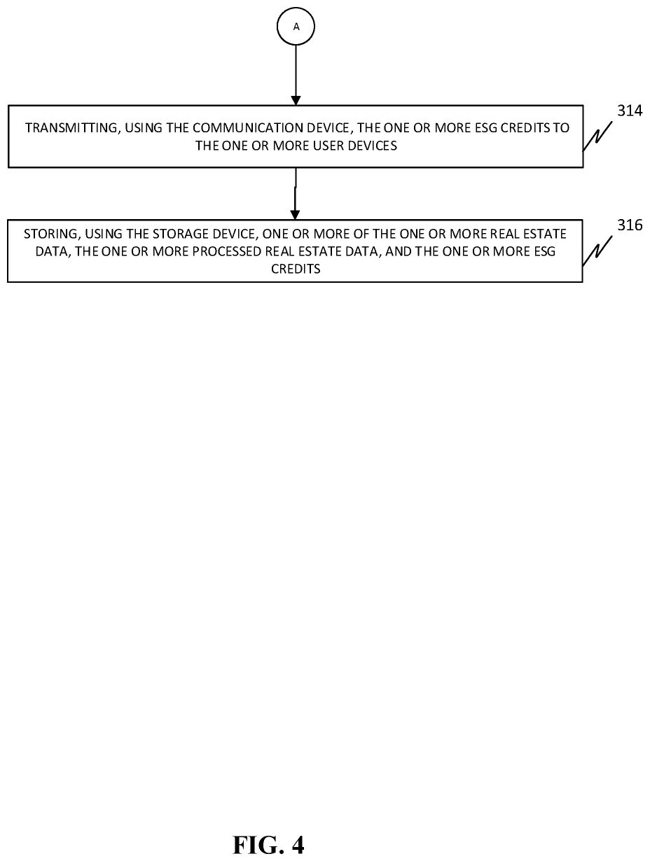

FIG. 4 is a continuation flowchart of FIG. 3.

Further, the method 300 may include a step 314 of transmitting, using the communication device, the one or more ESG credits to the one or more user devices.

Further, the method 300 may include a step 316 of storing, using the storage device, one or more of the one or more real estate data, the one or more processed real estate data, and the one or more ESG credits.

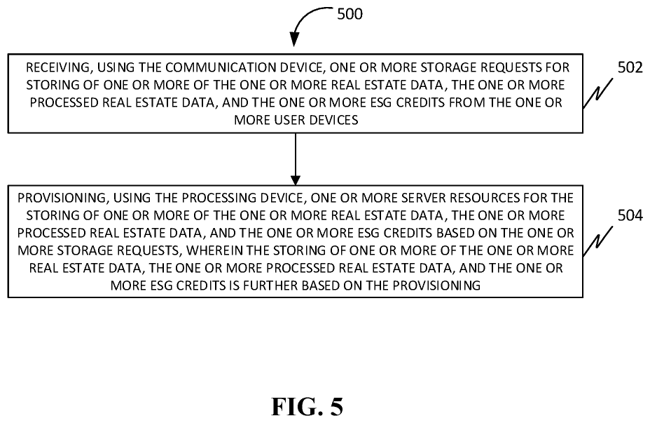

FIG. 5 is a flowchart of a method 500 for facilitating dynamic sustainability mapping of real estate in which the method 500 further may include provisioning one or more server resources for the storing one or more of the one or more real estate data, the one or more processed real estate data, and the one or more ESG credits based on the one or more storage requests, in accordance with some embodiments. Further, at 502, the method 500 may include receiving, using the communication device, one or more storage requests for storing one or more of the one or more real estate data, the one or more processed real estate data, and the one or more ESG credits from the one or more user devices. Further, at 504, the method 500 may include provisioning, using the processing device, one or more server resources for the storing of one or more of the one or more real estate data, the one or more processed real estate data, and the one or more ESG credits based on the one or more storage requests. Further, the storing of one or more of the one or more real estate data, the one or more processed real estate data, and the one or more ESG credits may be based on the provisioning. Further, the one or more server resources may be provided by one or more servers. Further, the one or more servers may be associated with Microsoft Office 365.

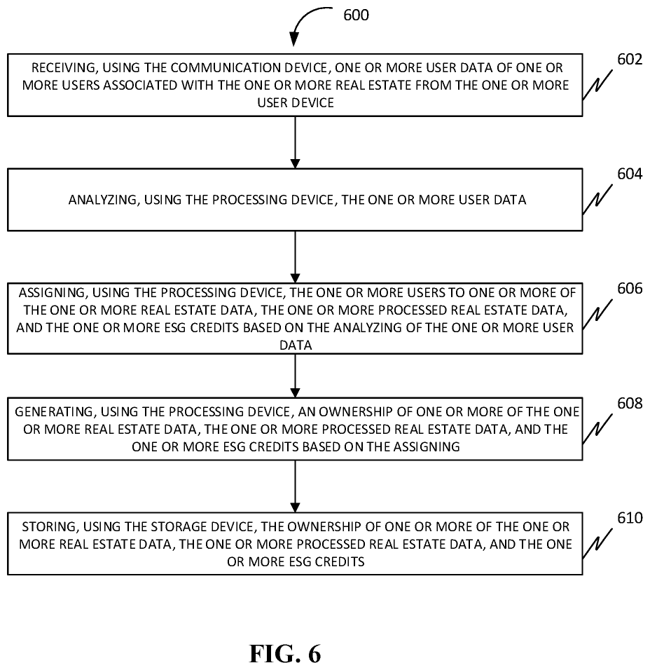

FIG. 6 is a flowchart of a method 600 for facilitating dynamic sustainability mapping of real estate in which the method 600 further may include storing the ownership of one or more of the one or more real estate data, the one or more processed real estate data, and the one or more ESG credits, in accordance with some embodiments. Further, at 602, the method 600 may include receiving, using the communication device, one or more user data of one or more users associated with the one or more real estate from the one or more user devices. Further, the one or more user data may include a user's identifiers, a user's credentials, a user's profile, a user's ownership, etc. Further, the one or more users may be uniquely identified based on the one or more user data. Further, at 604, the method 600 may include analyzing, using the processing device, the one or more user data. Further, at 606, the method 600 may include assigning, using the processing device, the one or more users to one or more of the one or more real estate data, the one or more processed real estate data, and the one or more ESG credits based on the analyzing of the one or more user data. Further, at 608, the method 600 may include generating, using the processing device, an ownership of one or more of the one or more real estate data, the one or more processed real estate data, and the one or more ESG credits based on the assigning. Further, at 610, the method 600 may include storing, using the storage device, the ownership of one or more of the one or more real estate data, the one or more processed real estate data, and the one or more ESG credits.

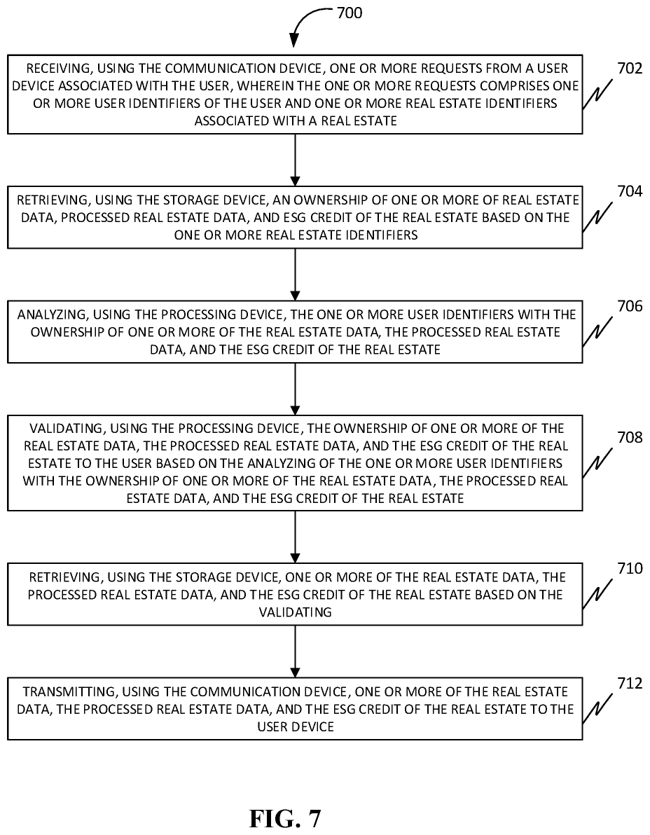

FIG. 7 is a flowchart of a method 700 for facilitating dynamic sustainability mapping of real estate in which the method 700 further may include transmitting one or more of the real estate data, the processed real estate data, and the ESG credit of the real estate to the user device, in accordance with some embodiments. Further, at 702, the method 700 may include receiving, using the communication device, one or more requests from a user device associated with the user. Further, the one or more requests may include one or more user identifiers of the user and one or more real estate identifiers associated with a real estate. Further, at 704, the method 700 may include retrieving, using the storage device, an ownership of one or more of real estate data, processed real estate data, and ESG credit of the real estate based on the one or more real estate identifiers. Further, at 706, the method 700 may include analyzing, using the processing device, the one or more user identifiers with the ownership of one or more of the real estate data, the processed real estate data, and the ESG credit of the real estate. Further, at 708, the method 700 may include validating, using the processing device, the ownership of one or more of the real estate data, the processed real estate data, and the ESG credit of the real estate to the user based on the analyzing of the one or more user identifiers with the ownership of one or more of the real estate data, the processed real estate data, and the ESG credit of the real estate. Further, at 710, the method 700 may include retrieving, using the storage device, one or more of the real estate data, the processed real estate data, and the ESG credit of the real estate based on the validating. Further, at 712, the method 700 may include transmitting, using the communication device, one or more of the real estate data, the processed real estate data, and the ESG credit of the real estate to the user device.

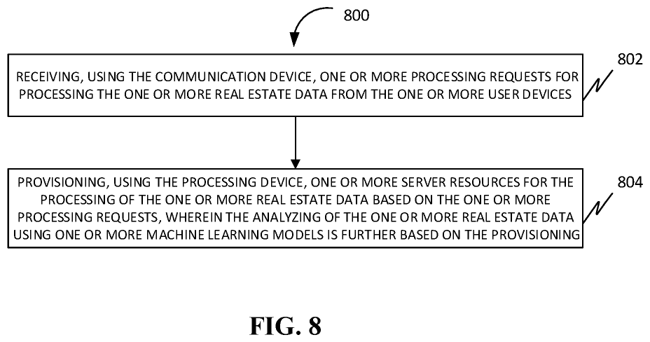

FIG. 8 is a flowchart of a method 800 for facilitating dynamic sustainability mapping of real estate in which the method 800 further may include provisioning one or more server resources for the processing of the one or more real estate data based on the one or more processing requests, in accordance with some embodiments. Further, at 802, the method 800 may include receiving, using the communication device, one or more processing requests for processing the one or more real estate data from the one or more user devices. Further, at 804, the method 800 may include provisioning, using the processing device, one or more server resources for the processing of the one or more real estate data based on the one or more processing requests. Further, the analyzing of the one or more real estate data using one or more machine learning models may be based on the provisioning.

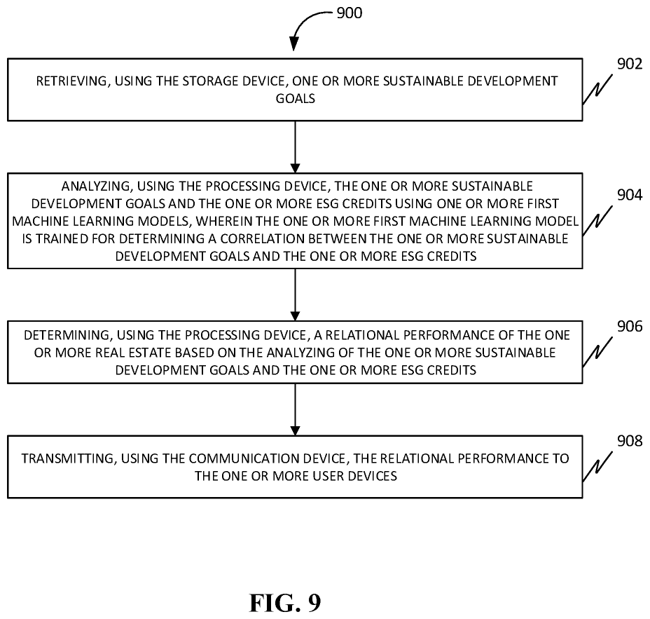

FIG. 9 is a flowchart of a method 900 for facilitating dynamic sustainability mapping of real estate in which the method 900 further may include transmitting the relational performance to the one or more user devices, in accordance with some embodiments. Further, at 902, the method 900 may include retrieving, using the storage device, one or more sustainable development goals. Further, the one or more sustainable development goals may include United Nations Sustainable Development Goals (UNSDGs). Further, at 904, the method 900 may include analyzing, using the processing device, the one or more sustainable development goals and the one or more ESG credits using one or more first machine learning models. Further, the one or more first machine learning models is trained for determining a correlation between the one or more sustainable development goals and the one or more ESG credits. Further, at 906, the method 900 may include determining, using the processing device, a relational performance of the one or more real estate based on the analyzing of the one or more sustainable development goals and the one or more ESG credits. Further, at 908, the method 900 may include transmitting, using the communication device, the relational performance to the one or more user devices.

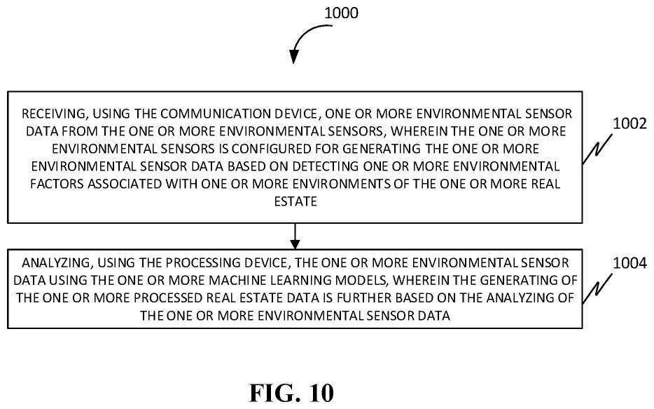

FIG. 10 is a flowchart of a method 1000 for facilitating dynamic sustainability mapping of real estate in which the method 1000 further may include analyzing the one or more environmental sensor data using the one or more machine learning models, in accordance with some embodiments. Further, at 1002, the method 1000 may include receiving, using the communication device, one or more environmental sensor data from the one or more environmental sensors. Further, the one or more environmental sensors may be configured for generating the one or more environmental sensor data based on detecting one or more environmental factors associated with one or more environments of the one or more real estate. Further, the one or more environmental factors may include temperature, pollutants, population density, sound, light, radiation, etc. Further, at 1004, the method 1000 may include analyzing, using the processing device, the one or more environmental sensor data using the one or more machine learning models. Further, the generating of the one or more processed real estate data may be based on the analyzing of the one or more environmental sensor data.

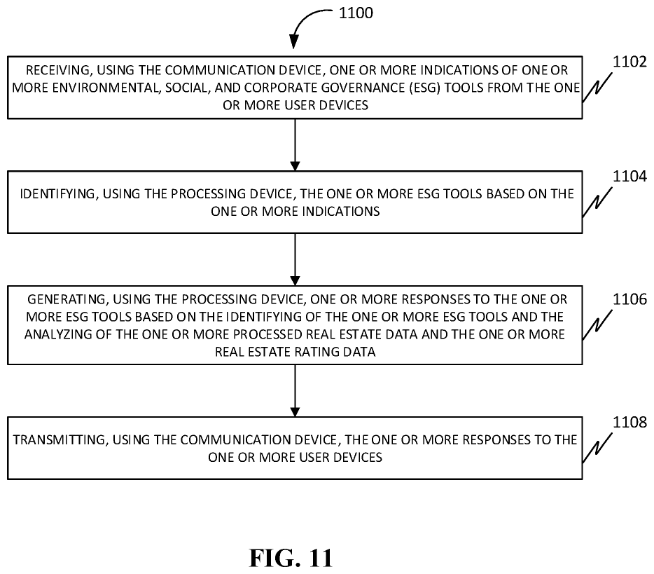

FIG. 11 is a flowchart of a method 1100 for facilitating dynamic sustainability mapping of real estate in which the method 1100 further may include transmitting the one or more responses to the one or more user devices, in accordance with some embodiments. Further, at 1102, the method 1100 may include receiving, using the communication device, one or more indications of one or more Environmental, Social, and Corporate Governance (ESG) tools from the one or more user devices. Further, at 1104, the method 1100 may include identifying, using the processing device, the one or more ESG tools based on the one or more indications. Further, at 1106, the method 1100 may include generating, using the processing device, one or more responses to the one or more ESG tools based on the identifying of the one or more ESG tools and the analyzing of the one or more processed real estate data and the one or more real estate rating data. Further, at 1108, the method 1100 may include transmitting, using the communication device, the one or more responses to the one or more user devices.

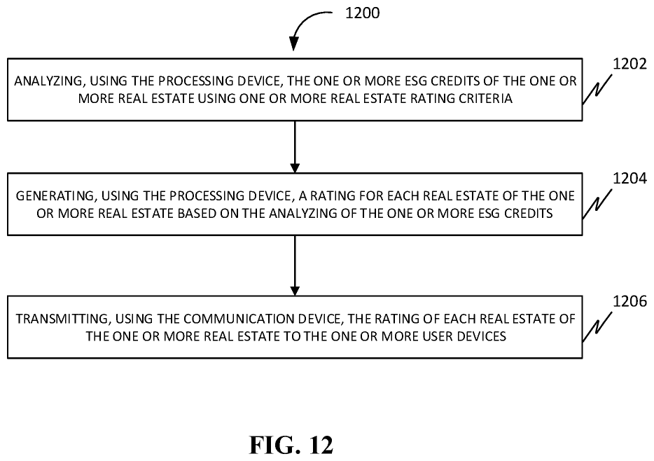

FIG. 12 is a flowchart of a method 1200 for facilitating dynamic sustainability mapping of real estate in which the method 1200 further may include transmitting the rating of each real estate of the one or more real estate to the one or more user devices, in accordance with some embodiments. Further, at 1202, the method 1200 may include analyzing, using the processing device, the one or more ESG credits of the one or more real estate using one or more real estate rating criteria. Further, at 1204, the method 1200 may include generating, using the processing device, a rating for each real estate of the one or more real estate based on the analyzing of the one or more ESG credits. Further, at 1206, the method 1200 may include transmitting, using the communication device, the rating of each real estate of the one or more real estate to the one or more user devices.

In some embodiments, the storing of one or more of the one or more real estate data, the one or more processed real estate data, and the one or more ESG credits may include storing one or more of the one or more real estate data, the one or more processed real estate data, and the one or more ESG credits in a distributed ledger.

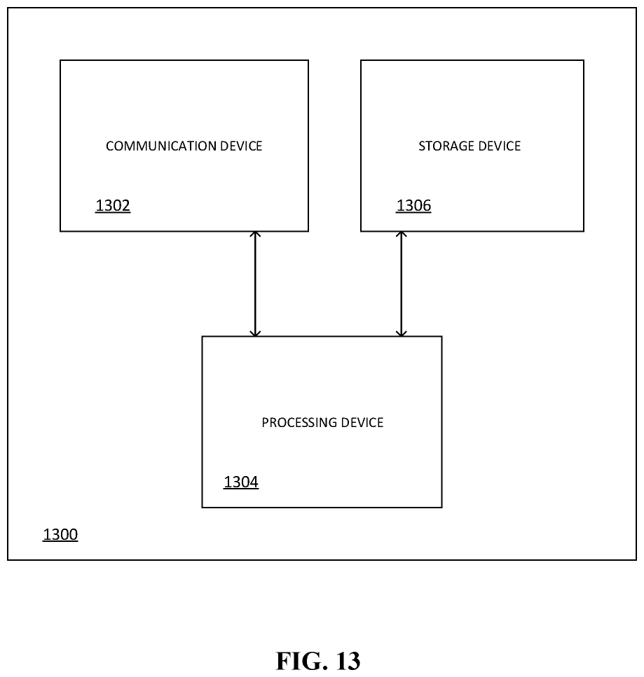

FIG. 13 is a block diagram of a system 1300 for facilitating dynamic sustainability mapping of real estate, in accordance with some embodiments. The system 1300 may include a communication device 1302, a processing device 1304, and a storage device 1306.

Further, the communication device 1302 may be configured for performing a step of receiving one or more real estate data associated with one or more real estate from one or more user devices.

Further, the communication device 1302 may be configured for performing a step of transmitting one or more ESG credits to the one or more user devices.

The processing device 1304 may be communicatively coupled with the communication device 1302.

Further, the processing device 1304 may be configured for performing a step of analyzing the one or more real estate data using one or more machine learning models. Further, the one or more machine learning models may be configured for one or more of an image recognition and a data extraction.

Further, the processing device 1304 may be configured for performing a step of generating one or more processed real estate data for the one or more real estate based on the analyzing.

Further, the processing device 1304 may be configured for performing a step of analyzing the one or more processed real estate data and one or more real estate rating data.

Further, the processing device 1304 may be configured for performing a step of generating the one or more Environmental, Social, and Corporate Governance (ESG) credits for the one or more real estate based on the analyzing of the one or more processed real estate data and the real estate rating data.

The storage device 1306 may be communicatively coupled with the processing device 1304.

Further, the storage device 1306 may be configured for performing a step of retrieving the one or more real estate rating data. Further, the one or more real estate rating data may include one or more world green building ratings.

Further, the storage device 1306 may be configured for performing a step of storing one or more of the one or more real estate data, the one or more processed real estate data, and the one or more ESG credits.

In some embodiments, the communication device 1302 may be configured for receiving one or more storage requests for storing one or more of the one or more real estate data, the one or more processed real estate data, and the one or more ESG credits from the one or more user devices. Further, the processing device 1304 may be configured for provisioning one or more server resources for the storing of one or more of the one or more real estate data, the one or more processed real estate data, and the one or more ESG credits based on the one or more storage requests. Further, the storing of one or more of the one or more real estate data, the one or more processed real estate data, and the one or more ESG credits may be based on the provisioning.

In some embodiments, the communication device 1302 may be configured for receiving one or more user data of one or more users associated with the one or more real estate from the one or more user devices. Further, the processing device 1304 may be configured for analyzing the one or more user data. Further, the processing device 1304 may be configured for assigning the one or more users to one or more of the one or more real estate data, the one or more processed real estate data, and the one or more ESG credits based on the analyzing of the one or more user data. Further, the processing device 1304 may be configured for generating an ownership of one or more of the one or more real estate data, the one or more processed real estate data, and the one or more ESG credits based on the assigning. Further, the storage device 1306 may be configured for storing the ownership of one or more of the one or more real estate data, the one or more processed real estate data, and the one or more ESG credits.

Further, in some embodiments, the communication device 1302 may be configured for receiving one or more requests from a user device associated with the user. Further, the one or more requests may include one or more user identifiers of the user and one or more real estate identifiers associated with a real estate. Further, the communication device 1302 may be configured for transmitting one or more of real estate data, processed real estate data, and ESG credit of the real estate to the user device. Further, the storage device 1306 may be configured for retrieving an ownership of one or more of the real estate data, the processed real estate data, and the ESG credit of the real estate based on the one or more real estate identifiers. Further, the storage device 1306 may be configured for retrieving one or more of the real estate data, the processed real estate data, and the ESG credit of the real estate based on the validating. Further, the processing device 1304 may be configured for analyzing the one or more user identifiers with the ownership of one or more of the real estate data, the processed real estate data, and the ESG credit of the real estate. Further, the processing device 1304 may be configured for validating the ownership of one or more of the real estate data, the processed real estate data, and the ESG credit of the real estate to the user based on the analyzing of the one or more user identifiers with the ownership of one or more of the real estate data, the processed real estate data, and the ESG credit of the real estate.

In some embodiments, the communication device 1302 may be configured for receiving one or more processing requests for processing the one or more real estate data from the one or more user devices. Further, the processing device 1304 may be configured for provisioning one or more server resources for the processing of the one or more real estate data based on the one or more processing requests. Further, the analyzing of the one or more real estate data using one or more machine learning models may be based on the provisioning.

In some embodiments, the storage device 1306 may be configured for retrieving one or more sustainable development goals. Further, the processing device 1304 may be configured for analyzing the one or more sustainable development goals and the one or more ESG credits using one or more first machine learning models. Further, the one or more first machine learning models may be trained for determining a correlation between the one or more sustainable development goals and the one or more ESG credits. Further, the processing device 1304 may be configured for determining a relational performance of the one or more real estate based on the analyzing of the one or more sustainable development goals and the one or more ESG credits. Further, the communication device 1302 may be configured for transmitting the relational performance to the one or more user devices. In some embodiments, the communication device 1302 may be configured for receiving one or more environmental sensor data from the one or more environmental sensors. Further, the one or more environmental sensors may be configured for generating the one or more environmental sensor data based on detecting one or more environmental factors associated with one or more environments of the one or more real estate. Further, the processing device 1304 may be configured for analyzing the one or more environmental sensor data using the one or more machine learning models. Further, the generating of the one or more processed real estate data may be based on the analyzing of the one or more environmental sensor data.

Further, in some embodiments, the processing device 1304 may be configured for analyzing the one or more ESG credits of the one or more real estate using one or more real estate rating criteria. Further, the processing device 1304 may be configured for generating a rating for each real estate of the one or more real estate based on the analyzing of the one or more ESG credits. Further, the communication device 1302 may be configured for transmitting the rating of each real estate of the one or more real estate to the one or more user devices.

Further, in some embodiments, the communication device 1302 may be configured for receiving one or more indications of one or more Environmental, Social, and Corporate Governance (ESG) may tool from the one or more user devices. Further, the communication device 1302 may be configured for transmitting one or more responses to the one or more user devices. Further, the processing device 1304 may be configured for identifying the one or more ESG tools based on the one or more indications. Further, the processing device 1304 may be configured for generating the one or more responses to the one or more ESG tools based on the identifying of the one or more ESG tools and the analyzing of the one or more processed real estate data and the one or more building rating data.

In some embodiments, the storing of one or more of the one or more real estate data, the one or more processed real estate data, and the one or more ESG credits may include storing one or more of the one or more real estate data, the one or more processed real estate data, and the one or more ESG credits in a distributed ledger.

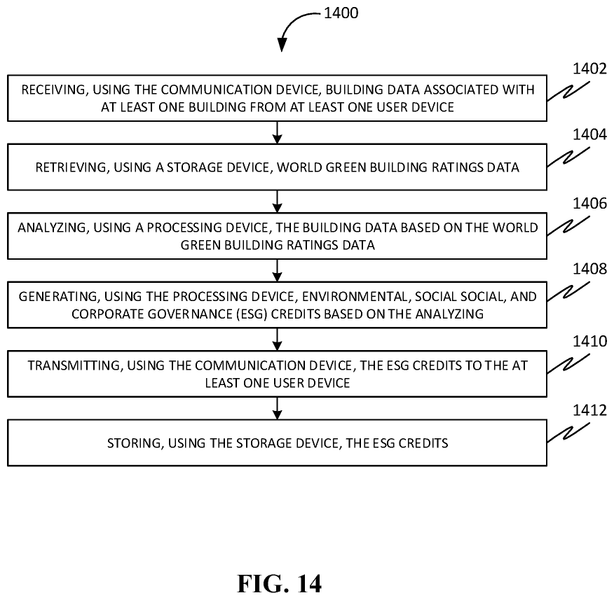

FIG. 14 is a flowchart of a method 1400 for facilitating dynamic sustainability mapping of a building, in accordance with some embodiments. Accordingly, at 1402, the method 1400 may include receiving, using a communication device (such as the communication device 1302), building data associated with at least one building from at least one user device. Further, the at least one building may include commercial real estate property. Further, the at least one user device may be associated with at least one user. Further, the at least one user may include property owners, real estate agencies/companies, building constructors, etc. Further, the at least one user device may include a smartphone, a mobile, a tablet, a laptop, a personal computer, etc. Further, the building data may include raw material information, design information, safety information, structural strength information, etc. associated with the at least one building.

Further, at 1404, the method 1400 may include a step of retrieving, using a storage device (such as the storage device 1306), World Green Building ratings data.

Further, at 1406, the method 1400 may include analyzing, using a processing device (such as the processing device 1304), the building data based on the World Green Building ratings data.

Further, at 1408, the method 1400 may include generating, using the processing device, Environmental, Social, and Corporate Governance (ESG) credits based on the analyzing. Further, the ESG credits may be associated with the at least one building. Further, the ESG credits may facilitate rating and audit process of the at least one building.

Further, at 1410, the method 1400 may include transmitting, using the communication device, the ESG credits to the at least one user device.

Further, at 1412, the method 1400 may include storing, using the storage device, the ESG credits.

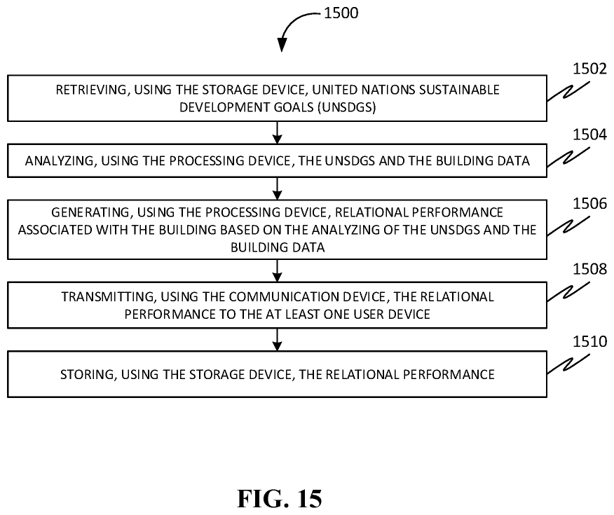

FIG. 15 is a flowchart of a method 1500 for determining relational performance for facilitating the dynamic sustainability mapping of the building, in accordance with some embodiments. Accordingly, at 1502, the method 1500 may include retrieving, using the storage device, United Nations Sustainable Development Goals (UNSDGs).

Further, at 1504, the method 1500 may include analyzing, using the processing device, the UNSDGs and the building data.

Further, at 1506, the method 1500 may include generating, using the processing device, relational performance associated with the at least one building based on the analyzing of the UNSDGs and the building data.

Further, at 1508, the method 1500 may include transmitting, using the communication device, the relational performance to the at least one user device.

Further, at 1510, the method 1500 may include storing, using the storage device, the relational performance.

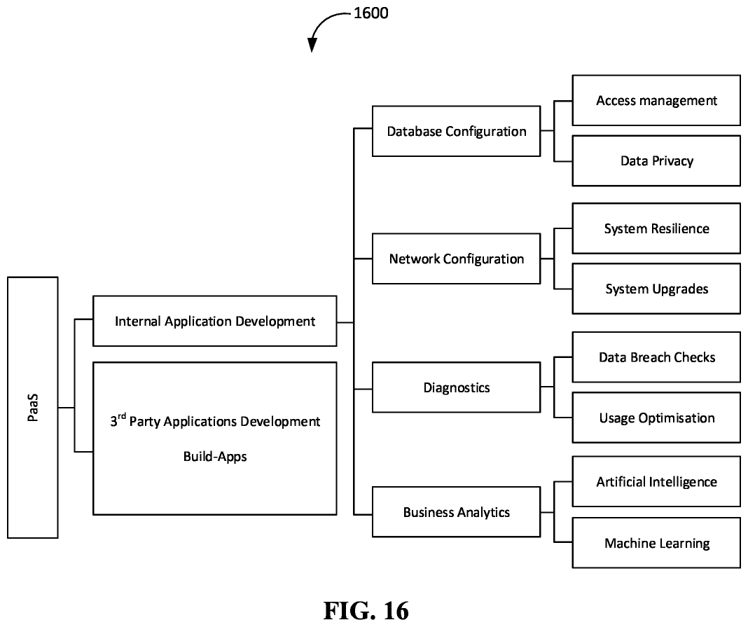

FIG. 16 illustrates a platform 1600 as a service associated with the disclosed system for facilitating dynamic sustainability mapping of real estate, in accordance with some embodiments. Accordingly, using Microsoft^{Tm} Power Platform PaaS (Platform as a Solution) and the software application (such as the Build-Apps), clients associated with the disclosed system may have truly independent and customizable market-leading IWMS (Integrated Workplace Management System).

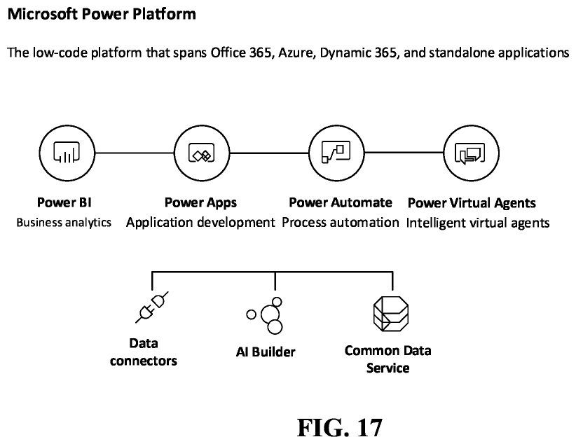

FIG. 17 illustrates services associated with the Microsoft Power platform, in accordance with some embodiments.

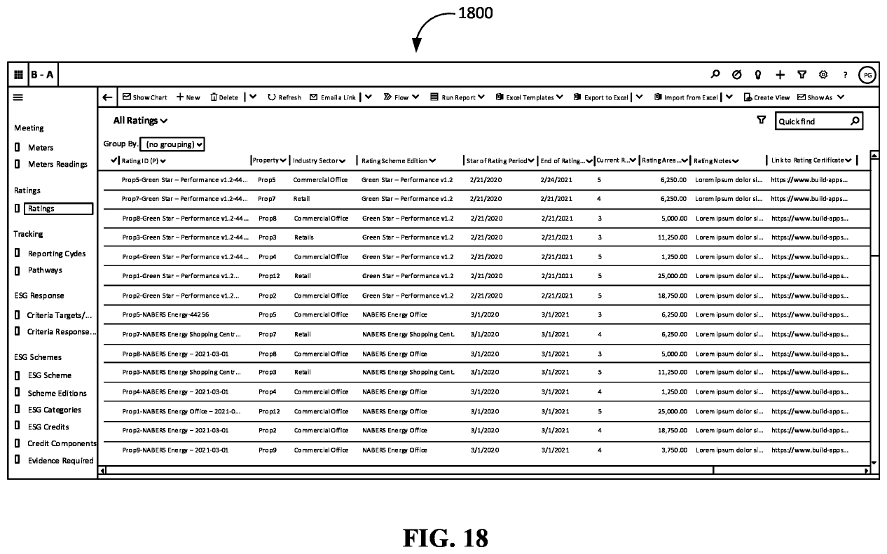

FIG. 18 is a screenshot of a user interface 1800 of a software application associated with the disclosed system, in accordance with some embodiments.

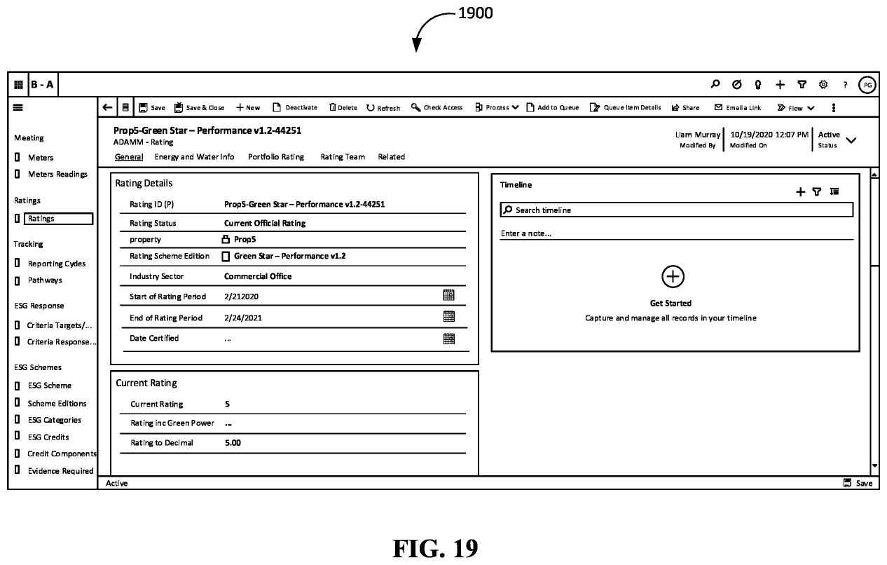

FIG. 19 is a screenshot of a user interface 1900 of the software application associated with the disclosed system, in accordance with some embodiments.

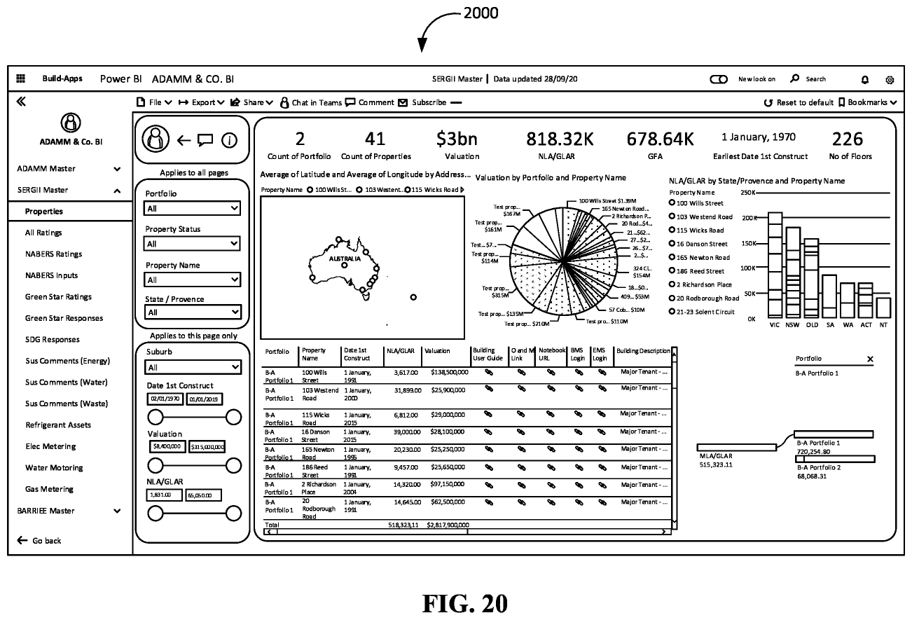

FIG. 20 is a screenshot of a “BI dashboard” user interface 2000 of the software application associated with the disclosed system, in accordance with some embodiments.

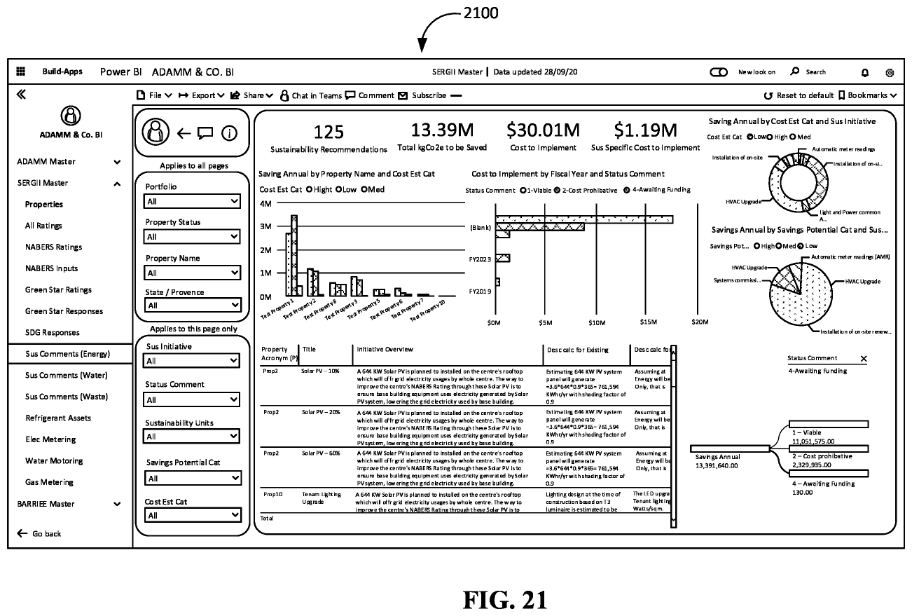

FIG. 21 is a screenshot of a “Energy comments” user interface 2100 of the software application associated with the disclosed system, in accordance with some embodiments.

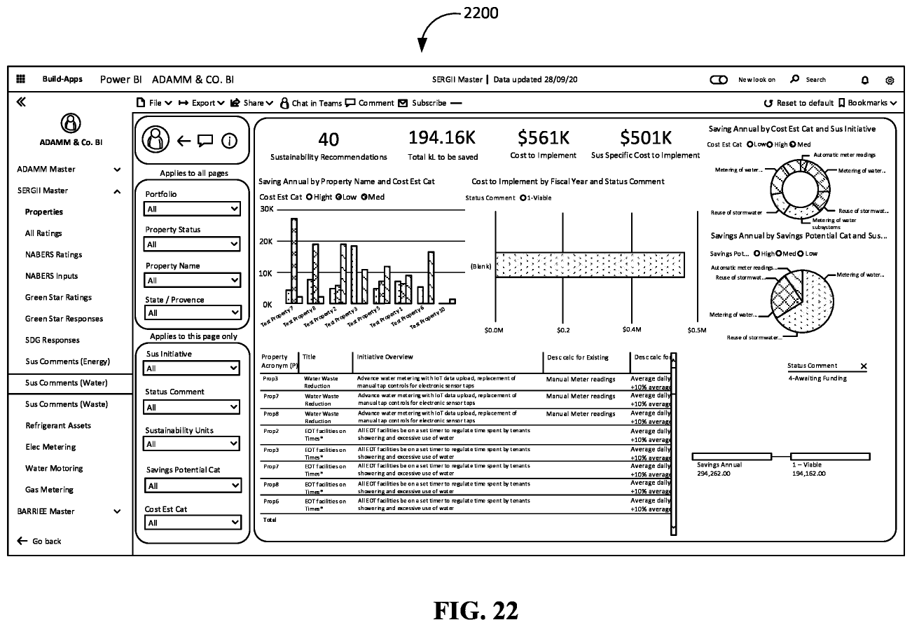

FIG. 22 is a screenshot of a “water comments” user interface 2200 of the software application associated with the disclosed system, in accordance with some embodiments.

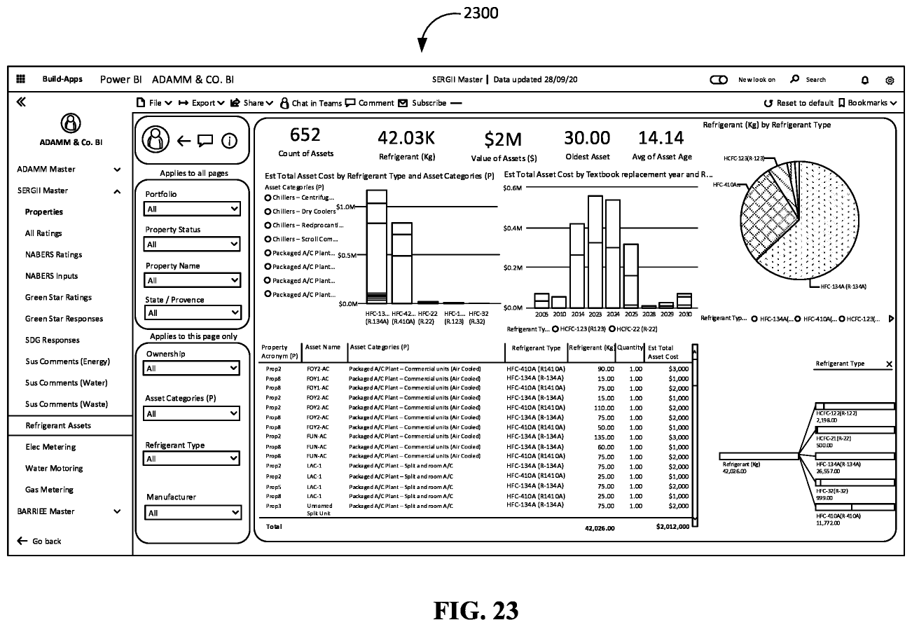

FIG. 23 is a screenshot of a “refrigerant assets” user interface 2300 of the software application associated with the disclosed system, in accordance with some embodiments.

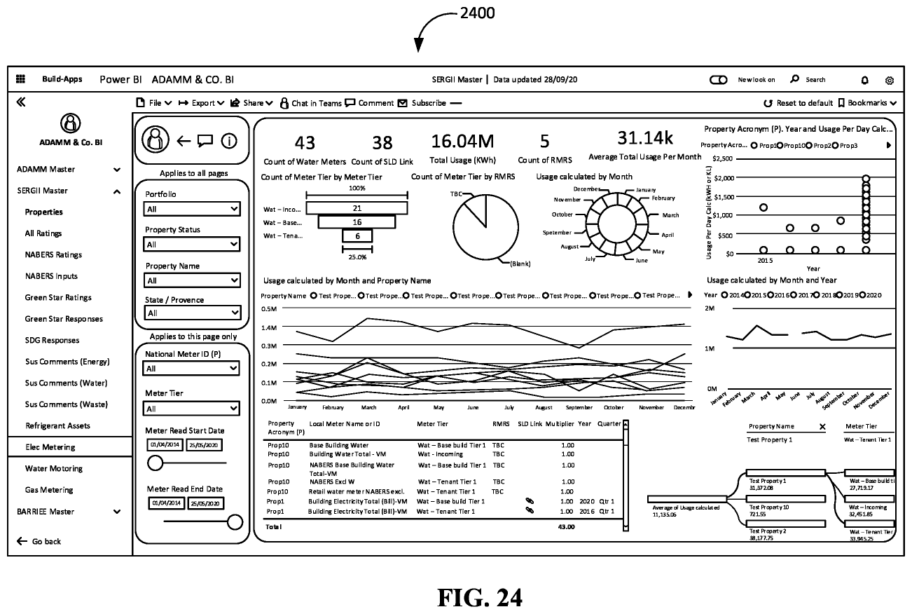

FIG. 24 is a screenshot of a “electricity metering” user interface 2400 of the software application associated with the disclosed system, in accordance with some embodiments.

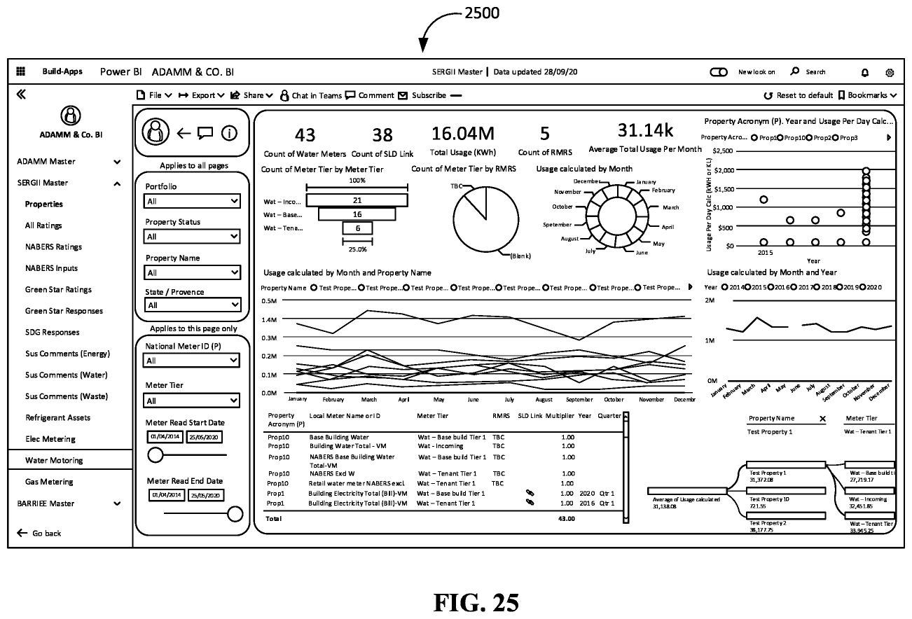

FIG. 25 is a screenshot of a “water metering” user interface 2500 of the software application associated with the disclosed system, in accordance with some embodiments.

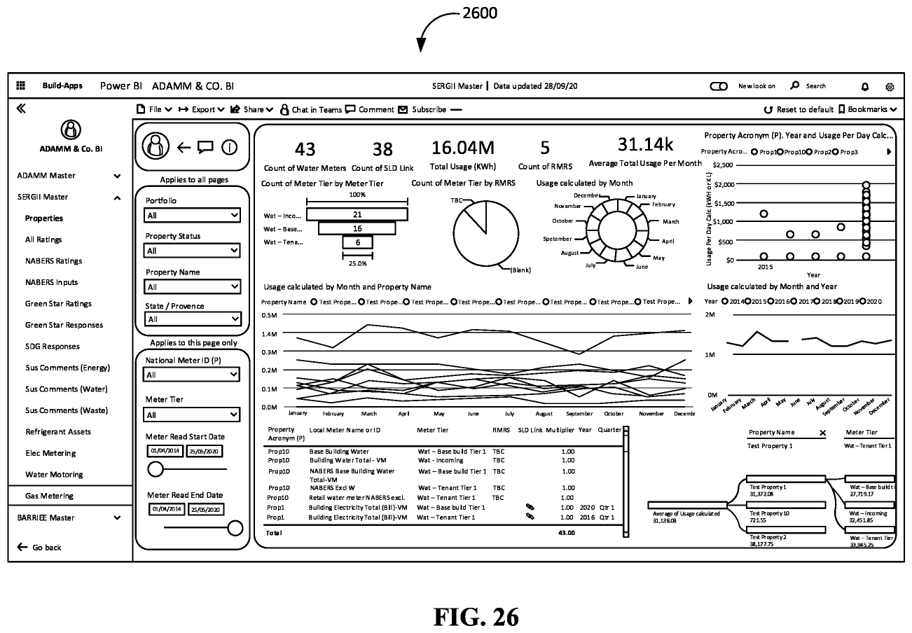

FIG. 26 is a screenshot of a “gas metering” user interface 2600 of the software application associated with the disclosed system, in accordance with some embodiments.

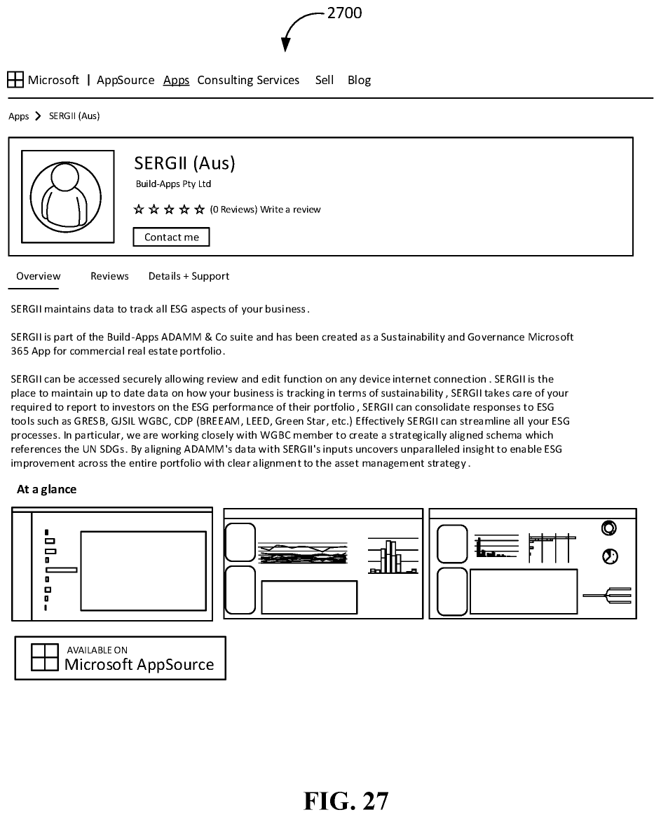

FIG. 27 is a screenshot of a “app source” user interface 2700 of the Microsoft AppSource, in accordance with some embodiments. Accordingly, the “app source” user interface 2700 shows the SERGII application associated with the disclosed system.

Although the present disclosure has been explained in relation to its preferred embodiment, it is to be understood that many other possible modifications and variations can be made without departing from the spirit and scope of the disclosure.

What is claimed is:

1. A method for facilitating dynamic sustainability mapping of real estate, the method comprising:
receiving, using a communication device, one or more real estate data associated with one or more real estate from one or more user devices;
analyzing, using a processing device, the one or more real estate data using one or more machine learning models, wherein the one or more machine learning models is configured for one or more of an image recognition and a data extraction;
generating, using the processing device, one or more processed real estate data for the one or more real estate based on the analyzing;
retrieving, using a storage device, one or more real estate rating data, wherein the one or more real estate rating data comprises one or more world green building ratings;
analyzing, using the processing device, the one or more processed real estate data and the one or more real estate rating data;
generating, using the processing device, one or more Environmental, Social, and Corporate Governance (ESG) credits for the one or more real estate based on the analyzing of the one or more processed real estate data and the real estate rating data;
transmitting, using the communication device, the one or more ESG credits to the one or more user devices; and
storing, using the storage device, one or more of the one or more real estate data, the one or more processed real estate data, and the one or more ESG credits.

2. The method of claim 1 further comprising:
receiving, using the communication device, one or more storage requests for storing one or more of the one or more real estate data, the one or more processed real estate data, and the one or more ESG credits from the one or more user devices; and
provisioning, using the processing device, one or more server resources for the storing of one or more of the one or more real estate data, the one or more processed real estate data, and the one or more ESG credits based on the one or more storage requests, wherein the storing of one or more of the one or more real estate data, the one or more processed real estate data, and the one or more ESG credits is further based on the provisioning.

3. The method of claim 1 further comprising:
receiving, using the communication device, one or more user data of one or more users associated with the one or more real estate from the one or more user devices;
analyzing, using the processing device, the one or more user data;
assigning, using the processing device, the one or more users to one or more of the one or more real estate data, the one or more processed real estate data, and the one or more ESG credits based on the analyzing of the one or more user data;
generating, using the processing device, an ownership of one or more of the one or more real estate data, the one or more processed real estate data, and the one or more ESG credits based on the assigning; and
storing, using the storage device, the ownership of one or more of the one or more real estate data, the one or more processed real estate data, and the one or more ESG credits.

4. The method of claim 3 further comprising:
receiving, using the communication device, one or more requests from a user device associated with the user, wherein the one or more requests comprises one or more user identifiers of the user and one or more real estate identifiers associated with a real estate;
retrieving, using the storage device, an ownership of one or more of real estate data, processed real estate data, and ESG credit of the real estate based on the one or more real estate identifiers;
analyzing, using the processing device, the one or more user identifiers with the ownership of one or more of the real estate data, the processed real estate data, and the ESG credit of the real estate;
validating, using the processing device, the ownership of one or more of the real estate data, the processed real estate data, and the ESG credit of the real estate to the user based on the analyzing of the one or more user identifiers with the ownership of one or more of the real estate data, the processed real estate data, and the ESG credit of the real estate;
retrieving, using the storage device, one or more of the real estate data, the processed real estate data, and the ESG credit of the real estate based on the validating; and
transmitting, using the communication device, one or more of the real estate data, the processed real estate data, and the ESG credit of the real estate to the user device.

5. The method of claim 1 further comprising:
receiving, using the communication device, one or more processing requests for processing the one or more real estate data from the one or more user devices; and
provisioning, using the processing device, one or more server resources for the processing of the one or more real estate data based on the one or more processing requests, wherein the analyzing of the one or more real estate data using one or more machine learning models is further based on the provisioning.

6. The method of claim 1 further comprising:
retrieving, using the storage device, one or more sustainable development goals;
analyzing, using the processing device, the one or more sustainable development goals and the one or more ESG credits using one or more first machine learning models, wherein the one or more first machine learning models is trained for determining a correlation between the one or more sustainable development goals and the one or more ESG credits;
determining, using the processing device, a relational performance of the one or more real estate based on the analyzing of the one or more sustainable development goals and the one or more ESG credits; and
transmitting, using the communication device, the relational performance to the one or more user devices.

7. The method of claim 1 further comprising:
receiving, using the communication device, one or more environmental sensor data from the one or more environmental sensors, wherein the one or more environmental sensors is configured for generating the one or more environmental sensor data based on detecting one or more environmental factors associated with one or more environments of the one or more real estate; and
analyzing, using the processing device, the one or more environmental sensor data using the one or more machine learning models, wherein the generating of the one or more processed real estate data is further based on the analyzing of the one or more environmental sensor data.

8. The method of claim 1 further comprising:
analyzing, using the processing device, the one or more ESG credits of the one or more real estate using one or more real estate rating criteria;
generating, using the processing device, a rating for each real estate of the one or more real estate based on the analyzing of the one or more ESG credits; and
transmitting, using the communication device, the rating of each real estate of the one or more real estate to the one or more user devices.

9. The method of claim 1 further comprising:
receiving, using the communication device, one or more indications of one or more Environmental, Social, and Corporate Governance (ESG) tools from the one or more user devices;
identifying, using the processing device, the one or more ESG tools based on the one or more indications;
generating, using the processing device, one or more responses to the one or more ESG tools based on the identifying of the one or more ESG tools and the analyzing of the one or more processed real estate data and the one or more real estate rating data; and
transmitting, using the communication device, the one or more responses to the one or more user devices.

10. The method of claim 1, wherein the storing of one or more of the one or more real estate data, the one or more processed real estate data, and the one or more ESG credits comprises storing one or more of the one or more real estate data, the one or more processed real estate data, and the one or more ESG credits in a distributed ledger.

11. A system for facilitating dynamic sustainability mapping of real estate, the system comprising:
a communication device configured for:
receiving one or more real estate data associated with one or more real estate from one or more user devices; and
transmitting one or more ESG credits to the one or more user devices;
a processing device communicatively coupled with the communication device, wherein the processing device is configured for:
analyzing the one or more real estate data using one or more machine learning models, wherein the one or more machine learning models is configured for one or more of an image recognition and a data extraction;
generating one or more processed real estate data for the one or more real estate based on the analyzing;
analyzing the one or more processed real estate data and one or more real estate rating data; and
generating the one or more Environmental, Social, and Corporate Governance (ESG) credits for the one or more real estate based on the analyzing of the one or more processed real estate data and the real estate rating data; and
a storage device communicatively coupled with the processing device, wherein the storage device is configured for:
retrieving the one or more real estate rating data, wherein the one or more real estate rating data comprises one or more world green building ratings; and
storing one or more of the one or more real estate data, the one or more processed real estate data, and the one or more ESG credits.

12. The system of claim 11, wherein the communication device is further configured for receiving one or more storage requests for storing one or more of the one or more real estate data, the one or more processed real estate data, and the one or more ESG credits from the one or more user devices, wherein the processing device is further configured for provisioning one or more server resources for the storing of one or more of the one or more real estate data, the one or more processed real estate data, and the one or more ESG credits based on the one or more storage requests, wherein the storing of one or more of the one or more real estate data, the one or more processed real estate data, and the one or more ESG credits is further based on the provisioning.

13. The system of claim 11, wherein the communication device is further configured for receiving one or more user data of one or more users associated with the one or more real estate from the one or more user devices, wherein the processing device is further configured for:
analyzing the one or more user data;
assigning the one or more users to one or more of the one or more real estate data, the one or more processed real estate data, and the one or more ESG credits based on the analyzing of the one or more user data; and
generating an ownership of one or more of the one or more real estate data, the one or more processed real estate data, and the one or more ESG credits based on the assigning, wherein the storage device is further configured for storing the ownership of one or more of the one or more real estate data, the one or more processed real estate data, and the one or more ESG credits.

14. The system of claim 13, wherein the communication device is further configured for:
receiving one or more requests from a user device associated with the user, wherein the one or more requests comprises one or more user identifiers of the user and one or more real estate identifiers associated with a real estate; and
transmitting one or more of real estate data, processed real estate data, and ESG credit of the real estate to the user device, wherein the storage device is further configured for:
retrieving an ownership of one or more of the real estate data, the processed real estate data, and the ESG credit of the real estate based on the one or more real estate identifiers; and
retrieving one or more of the real estate data, the processed real estate data, and the ESG credit of the real estate based on the validating, wherein the processing device is further configured for:
analyzing the one or more user identifiers with the ownership of one or more of the real estate data, the processed real estate data, and the ESG credit of the real estate;
validating the ownership of one or more of the real estate data, the processed real estate data, and the ESG credit of the real estate to the user based on the analyzing of the one or more user identifiers with the ownership of one or more of the real estate data, the processed real estate data, and the ESG credit of the real estate.

15. The system of claim 11, wherein the communication device is further configured for receiving one or more processing requests for processing the one or more real estate data from the one or more user devices, wherein the processing device is further configured for provisioning one or more server resources for the processing of the one or more real estate data based on the one or more processing requests, wherein the analyzing of the one or more real estate data using one or more machine learning models is further based on the provisioning.

16. The system of claim 11, wherein the storage device is further configured for retrieving one or more sustainable development goals, wherein the processing device is further configured for:
analyzing the one or more sustainable development goals and the one or more ESG credits using one or more first machine learning models, wherein the one or more first machine learning models is trained for determining a correlation between the one or more sustainable development goals and the one or more ESG credits; and
determining a relational performance of the one or more real estate based on the analyzing of the one or more sustainable development goals and the one or more ESG credits, wherein the communication device is further configured for transmitting the relational performance to the one or more user devices.

17. The system of claim 11, wherein the communication device is further configured for receiving one or more environmental sensor data from the one or more environmental sensors, wherein the one or more environmental sensors is configured for generating the one or more environmental sensor data based on detecting one or more environmental factors associated with one or more environments of the one or more real estate, wherein the processing device is further configured for analyzing the one or more environmental sensor data using the one or more machine learning models, wherein the generating of the one or more processed real estate data is further based on the analyzing of the one or more environmental sensor data.

18. The system of claim 11, wherein the processing device is further configured for:
analyzing the one or more ESG credits of the one or more real estate using one or more real estate rating criteria; and
generating a rating for each real estate of the one or more real estate based on the analyzing of the one or more ESG credits, wherein the communication device is further configured for transmitting the rating of each real estate of the one or more real estate to the one or more user devices.

19. The system of claim 11, wherein the communication device is further configured for:
receiving one or more indications of one or more Environmental, Social, and Corporate Governance (ESG) tools from the one or more user devices; and
transmitting one or more responses to the one or more user devices, wherein the processing device is further configured for:
identifying the one or more ESG tools based on the one or more indications; and
generating the one or more responses to the one or more ESG tools based on the identifying of the one or more ESG tools and the analyzing of the one or more processed real estate data and the one or more building rating data.

20. The system of claim 11, wherein the storing of one or more of the one or more real estate data, the one or more processed real estate data, and the one or more ESG credits comprises storing one or more of the one or more real estate data, the one or more processed real estate data, and the one or more ESG credits in a distributed ledger.
